(19) United States
(12) Patent Application Publication
(10) Pub. No.: US 2014/0338882 A1
(43) Pub. Date: Nov. 20, 2014

(54) HVAC Control for Vehicles with Start/Stop Engines

(71) Applicant: Ford Global Technologies, LLC, Dearborn, MI (US)

(72) Inventors: James Rollinson, Superior Township, MI (US); Paul Bryan Hoke, Plymouth, MI (US); Michael Steven Wallis, Belleville, MI (US)

(73) Assignee: Ford Global Technologies, LLC, Dearborn, MI (US)

(21) Appl. No.: 13/894,486

(22) Filed: May 15, 2013

(51) Int. Cl. B60H 1/00

(52) U.S. Cl. CPC B60H 1/00742; B60H 1/00778; B60H 1/00878; B60H 1/00985
USPC 165/203; 165/42

(57) ABSTRACT

A vehicle climate control system is provided. The vehicle climate control system allows an occupant in the rear area of a vehicle to control the climate settings in the vehicle. It comprises a front climate interface, a rear climate interface, and a controller. When actuated, the controller disables the front climate interface and allows the rear climate interface to determine the climate settings. The controller is also operative to selectively restart a vehicle engine in order to reduce fuel consumption. The vehicle climate control system may be disabled when the engine is off and selectively enabled when the engine is operating.

### TECHNICAL FIELD

The present invention relates to a system for controlling a heating ventilation and air conditioning (“HVAC”) system in vehicles with start/stop engines.

### BACKGROUND

To increase fuel economy vehicle engines may be equipped with an engine start/stop system. The engine start/stop system shuts off the engine when the vehicle is idle. Currently, only front seat occupants are able to override the engine start/stop system based on desired climate settings. However, an occupant in the rear passenger area of a chauffeured vehicle may be the owner of the vehicle and the person whose comfort is of paramount importance. The vehicle owner is not able to control the climate settings of the chauffeured vehicle when the engine stops because of the normal front seat control bias.

One way of improving occupant comfort in a vehicle is to use a climate control system that has a control unit for adjusting the direction of airflow. An air control vent may be adjusted to redirect the direction of the airflow. These systems do not control the start/stop system of the vehicle HVAC system of the vehicle that limits the operation of the vehicle HVAC system and can fail to keep a chauffeured person in the rear seat comfortable when the engine is stopped to save fuel.

Another system for increasing occupant comfort in a vehicle is to determine the blowout condition of the conditioned air. This is done by using an electronic control unit on both the front and rear air conditioning units. Such systems do not allow independent control of the front air conditioning unit and the rear air conditioning unit. The control unit does not allow the occupant in the rear of a vehicle to control an engine start/stop system based upon the comfort level of the rear seat occupants.

Another way of controlling temperature in an automotive vehicle is to have an interface that allows a user to select a driver side temperature setting and a passenger side temperature setting. A seat occupancy sensor may detect whether the passenger seat is occupied and send a signal to a vehicle climate control system controller. When the passenger side area is unoccupied, the climate control system distributes conditioned air according to the driver side temperature setting to both the driver side and the passenger side areas. This type of system only controls the distribution of conditioned air to the front of the vehicle. Such systems do not include an auxiliary HVAC control for rear seat occupants and do not control the engine start/stop system.

This disclosure is directed to the above problems and other problems as summarized below.

### SUMMARY

According to one aspect of this disclosure, a vehicle HVAC system is described that comprises a front control interface, a rear control interface, and a climate controller. The front control interface may be manipulated by the driver in the front seat. Manipulating the front control interface controls the climate setting for both the front and rear areas of the vehicle. The rear control interface, located in the rear area of the vehicle, is accessible to be manipulated by a passenger seated in the rear area. The controller may be commanded to disable the front control interface and enable the rear control interface to control the climate setting for the rear area.

The controller may be actuated by the rear control interface when the vehicle is determined to be a chauffeured vehicle. A selector switch, located in the front area of the vehicle, may be manually actuated to transfer control to the rear area. Alternatively, the controller may be actuated upon detection of a passenger seated in the rear area of the vehicle. A seat occupancy sensor, located in the rear area of the vehicle, may be provided to detect that a rear seat is occupied. There are several ways of detecting that a rear is occupied including a sensor located in the seat, a sensor in the seat belt receiver, a motion detector, a passenger detecting camera, or the like.

The vehicle HVAC system may be for a vehicle that is equipped with an engine capable of being enabled and disabled to reduce fuel consumption. When the engine is disabled, the controller may need to restart the engine to control the climate within the vehicle. The controller may restart the engine when selected climate settings in either the front or the rear areas of the vehicle differ from the current climate in the selected area.

According to another aspect of this disclosure, a HVAC system for a vehicle is described that comprises a front climate interface, a rear climate interface, an occupant sensor, a selector switch, and a controller. The controller may allow the rear climate interface to control the climate settings of a front area and a rear area. When the occupant sensor determines the presence of a rear passenger and the selector switch is actuated, the controller may be programmed to allow the rear control interface to have sole control over climate determinations in the vehicle. The controller prevents a vehicle engine from shutting off when a selected climate setting is outside a climate setting range determined from either the front climate interface or the rear climate interface.

The controller may be actuated by a selector switch located in a front area that may be actuated by a driver in the front area, or by monitoring a sensor or other input indicating that the vehicle is chauffeured. For example, when the vehicle is being chauffeured, the position of the front passenger seat may be shifted forward to provide additional space for the chauffeured person and a seat position sensor may indicate the vehicle is being chauffeured. When a passenger in the rear area is detected, the controller is to be controlled by the rear control interface.

When the selector switch, the seat position switch, or the seat occupancy sensor is actuated, the controller may be programmed to determine that the vehicle is being chauffeured. Once the controller determines that the vehicle is being chauffeured, the controller biases the climate control to the rear climate interface in the rear area of the vehicle. Biasing the climate control to the rear climate interface causes the climate control system to seek to achieve a selected climate of the rear area. Climate sensors monitoring blower voltage, duct temperature, coolant temperature, and relative cabin humidity may be used to determine the climate settings to control the climate of the rear area.

According a further aspect of this disclosure a control system is described that comprises a control circuit, a HVAC system, an input, and a climate sensor. The control circuit is configured to enable and disable an engine to reduce fuel consumption. When the engine is disabled, the HVAC system may be disabled. Likewise, when the engine is enabled, the HVAC system is selectively enabled. An input indicative of a rear seat being occupied is communicated to the control circuit to indicate the presence of a chauffeured passenger. When the control circuit receives the input, the rear area climate sensor controls the HVAC system.

The input may be provided in a variety of ways. For example, the input may be a sensor operatively connected to the rear seat. The sensor may be a seat belt sensor in the rear seat, a seat pressure sensor in the rear seat, or a motion detecting sensor activated upon movement in the rear seat. Further, the sensor may be a seat position sensor that provides the input. The seat position sensor may be actuated when a front seat is shifted into a position providing added leg room for the rear seat. The engine may be a combustion engine that provides all traction power for the vehicle. Alternatively, the engine may be an internal combustion engine of a hybrid vehicle that includes an electric traction motor and a battery.

The above aspects of the disclosure and other aspects will be better understood in view of the attached drawings and the following detailed description of the illustrated embodiments.

### BRIEF DESCRIPTION OF THE DRAWINGS

FIG. 1 is a top plan view of a chauffeured vehicle.

FIG. 2 is a diagrammatic view the climate control system.

### DETAILED DESCRIPTION

The illustrated embodiments are disclosed with reference to the drawings. It should be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but merely as a representative basis for teaching one skilled in the art how to practice the disclosed concepts.

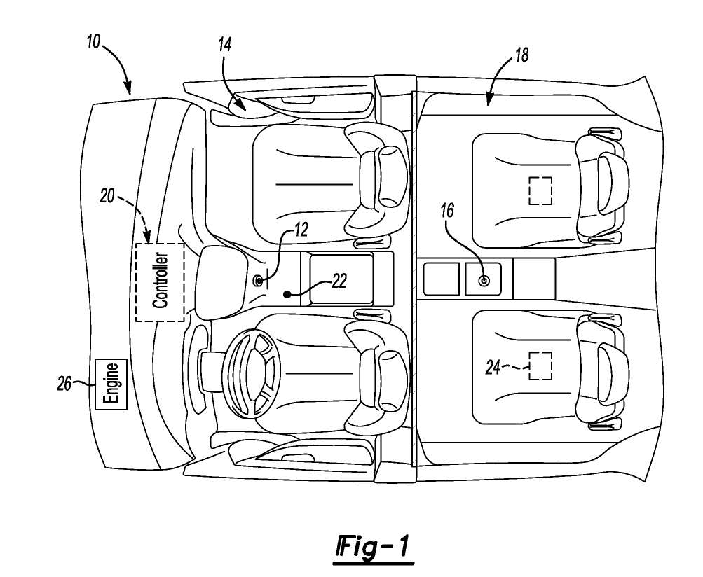

Referring to FIG. 1, a vehicle 10 is shown that includes a front climate interface 12 within the front area 14 and a rear climate interface 16 within the rear area 18. A driver (not shown) in the front area 14 may manipulate the front climate interface 12 to select a climate setting in the front and rear areas 14, 18. The rear climate interface 16 may be manipulated by a rear seat passenger (not shown) to select a climate setting in the rear area 18. A controller 20 may disable the front climate interface 12 to allow the rear climate interface 16 to select the climate settings of the rear area 18. The controller 20 may also allow the rear climate interface 16 to control the climate settings in the front area 14.

A selector switch 22 may be actuated to indicate to the controller 20 that the vehicle 10 is being driven by a chauffeur. The selector switch 22 may be located in the front area 14 and may be actuated manually by the driver in the front area 14. A change in the position of the front passenger seat may also be used to indicate to the controller that the driver is a chauffeur. When the front passenger seat is pushed fully forward, the controller 20 may be switched to allow the rear climate interface 16 to determine the climate settings for the front area 14 and the rear area 18.

The controller 20 may also transfer control to the rear climate interface 16 upon sensing the presence of a passenger (not shown) in the rear area 18. A seat occupancy sensor 24 in the rear area 18 may be actuated by the presence of a rear area 18 passenger. The climate settings for the front area 14 and the rear area 18 may be set by the rear climate interface 16 when the controller 20 determines the presence of a chauffeured passenger.

The vehicle 10 also comprises an engine 26 that selectively generates engine power. The controller 20 controls the climate settings in the front 14 and rear 18 areas. The controller 20 may command restarting the engine 26 when the engine 26 is turned off and the climate settings of the selected front area 14 or rear area 18 require engine operation to provide heat or air conditioning. The rear climate interface 16 may be used to control the climate in the rear area 18 if the controller 20 determines the presence of a chauffeured passenger.

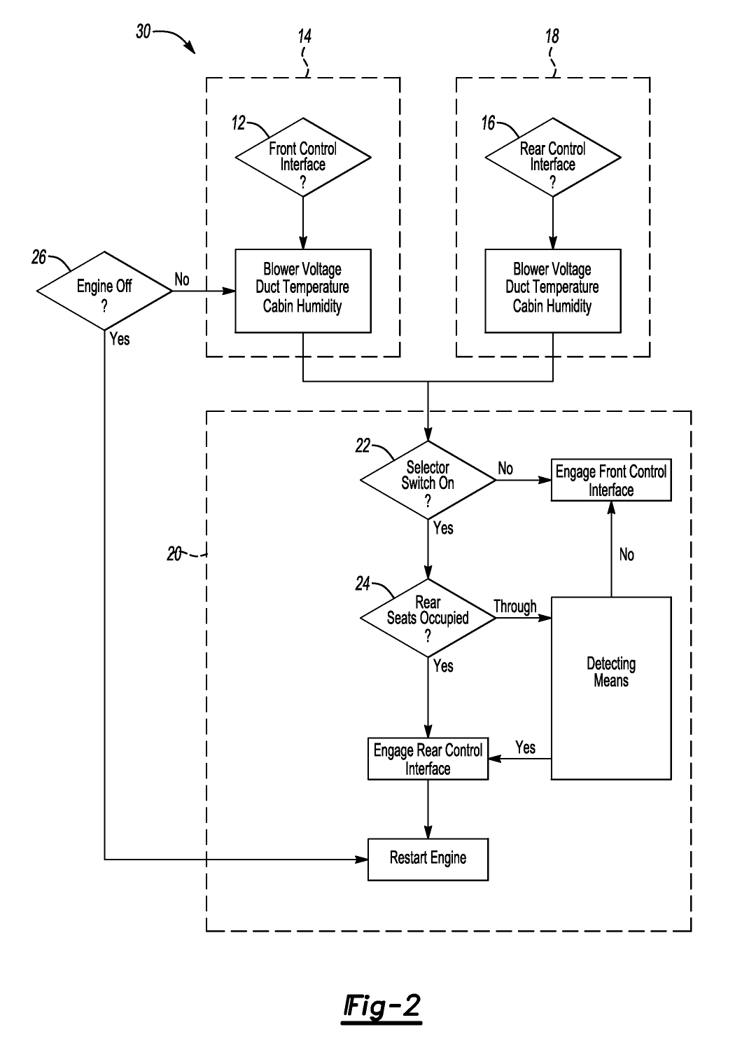

FIG. 2 is a diagrammatic view illustrating operation of a climate control system 30. The system 30 comprises a front climate interface 12 for controlling climate settings in a front area 14 and a rear area 18. A rear climate interface 16 controls the climate setting in at least the rear area 18. A controller 20, when actuated, dictates whether the front control interface 12 or the rear control interface 16 controls the climate setting in the rear area 18.

The controller 20 may be actuated by a selector switch 22 that causes the rear climate interface 16 to govern the climate settings in the rear area 18. When disengaged, the selector switch 22 does not actuate the controller 20 and the front climate interface 12 controls the climate setting for the front 14 and rear 18 areas. The controller 20 may also be actuated by a seat occupancy sensor 24. The seat occupancy sensor 24 detects the presence of a rear passenger (not shown) and when engaged in combination with the selector switch 22 actuates the controller 20. Once the controller 20 is actuated, the rear climate interface 16 controls the climate settings of the rear area 18.

The climate control system 30 may also cooperate with an engine 26. The engine 26 is capable of being enabled and disabled to reduce fuel consumption. When the engine 26 is disabled, the climate control system 30 may also be disabled. When the selected climate is different from the climate setting in the selected front area 14 or rear area 18 and the engine 26 is disabled, the controller 20 may be operative to restart the engine 26. Restarting the engine 26 allows the climate control system 30 to account for the change in climate in the front 14 and rear 18 areas based on the selected climate of the front 12 or rear 16 climate interfaces.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle heating ventilation and air conditioning system comprising:
a front control interface positioned in a front area of the vehicle and operative to be manipulated by a driver seated in the front area to control a climate setting in each of the front area and a rear area of the vehicle;
a rear control interface positioned in the rear area and operative to be manipulated by a passenger seated in the rear area to control the climate setting in the rear area; and
a controller upon being actuated being operative to disable the front control interface from being operative to control the climate setting in the rear area such that the rear control interface has sole control of the climate setting in the rear area.

2. The vehicle heating ventilation and air conditioning system of claim 1 wherein:
the rear control interface is further operative to be manipulated by a passenger seated in the rear area to control the climate setting in the front area.

3. The vehicle heating ventilation and air conditioning system of claim 2 wherein:
the controller upon being actuated is further operative to disable the front control interface from being operative to control the climate setting in the front area such that the rear control interface has sole control of the climate setting in each of the front area and the rear area.

4. The vehicle heating ventilation and air conditioning system of claim 1 wherein:
the controller is operative to be actuated upon detection of the driver being a chauffeur of the vehicle.

5. The vehicle heating ventilation and air conditioning system of claim 4 further comprising:
a selector switch positioned in the front area and operative to be manipulated by a driver seated in the front area to indicate that the driver is a chauffeur of the vehicle, the controller being in communication with the selector switch such that the controller is actuated upon the selector switch being manipulated to indicate that the driver is a chauffeur of the vehicle.

6. The vehicle heating ventilation and air conditioning system of claim 4 wherein:
the controller is further operative to monitor a position of a seat in the front area and to detect the driver being a chauffeur of the vehicle when the position of the seat is in a position different from a seat position associated with an owner of the vehicle.

7. The vehicle heating ventilation and air conditioning system of claim 1 wherein:
the controller is operative to be actuated upon detection of a passenger being seated in the rear area.

8. The vehicle heating ventilation and air conditioning system of claim 7 further comprising:
a seat occupant sensor operative to detect whether a passenger is seated in the rear area, the controller being in communication with the seat occupant sensor such that the controller is actuated upon the seat occupant sensor detecting a passenger being seated in the rear area.

9. The vehicle heating ventilation and air conditioning system of claim 1 wherein:
the controller is operative to be actuated upon detection of the driver being a chauffeur of the vehicle and upon detection of a passenger seated in the rear area being a chauffeured passenger.

10. The vehicle heating ventilation and air conditioning system of claim 1 further comprising:
a selector switch positioned in the front area and operative to be manipulated by a driver seated in the front area to either enable actuation or disable actuation of the controller, whereby the front control interface is operative to control the climate setting in the rear area when actuation of the controller is disabled.

11. The vehicle heating ventilation and air conditioning system of claim 1 further comprising:
an engine configured to be enabled and disabled to reduce fuel consumption by the controller; and
wherein the controller is further operative to restart the engine, after the engine has been disabled, based on a climate setting of a selected one of the front and rear areas being different from a climate of one of the front and rear areas.

12. A heating ventilation and air conditioning system for a vehicle having an engine start/stop system, comprising:
a front climate interface operable to determine a climate setting of a front area and a rear area;
a rear climate interface operable to determine a rear climate setting;
an occupant sensor operable to detect an occupied rear seat;
a selector switch actuatable by a vehicle occupant; and
a controller operative to allow the rear climate interface to control the climate setting of the rear area under the conditions of a detected rear occupant or an actuated selector switch, wherein the controller prevents a vehicle engine from shutting off when the climate settings are outside a selected climate setting range based on the rear climate interface.

13. The heating ventilation and air conditioning system of claim 12 wherein:
the rear climate interface is further operative to be manipulated by a passenger seated in the rear area.

14. The heating ventilation and air conditioning system of claim 12 wherein:
the controller is further operative to change the climate of a selected one of the front or rear areas based upon the selected climate setting range.

15. The heating ventilation and air conditioning system of claim 12 further comprising:
at least one climate sensor operative to detect a current climate setting in each of the front and rear areas.

16. A control system comprising:
a control circuit enables and disables an engine to reduce fuel consumption;
a heating ventilation and air conditioning system may be disabled when the engine is off
and is selectively enabled when the engine is operating;
an input indicative of a rear seat being occupied provided to the control circuit; and a climate sensor controls the heating ventilation and air conditioning system based upon a rear seat condition when the input is received by the control circuit.

17. The control system of claim 16 further comprising:
a sensor monitoring the rear seat that provides the input indicative of the rear seat being occupied.

18. The control system of claim 16 further comprising:
a seat position sensor attached to a front seat that provides the input when the front seat is shifted to a position to provide added leg room for the rear seat.

19. The control system of claim 16 wherein:
the engine is an internal combustion engine that is part of a hybrid electric vehicle that also includes an electric traction motor and a battery.

20. The control system of claim 16 wherein:
the engine is a combustion engine that provides all traction power for a vehicle.
